(19) United States
(12) Patent Application Publication
(10) Pub. No.: US 2007/0184412 A1
(43) Pub. Date: Aug. 9, 2007

(54) Method for producing a dental crown

(75) Inventors: Christian Borowski, Kiel (DE); Holger Knuth, Lutjenburg (DE)

Correspondence Address: MORRISON & FOERSTER LLP, 1650 TYSONS BOULEVARD, SUITE 400, MCLEAN, VA, 22102, US

(73) Assignee: Merz Dental Gmbh, Lutjenburg (DE)

(21) Appl. No.: 10/594,930

(22) PCT Filed: Mar. 29, 2005
(86) PCT No.: PCT/EP05/03251

§ 371 Date: Sep. 29, 2006

(30) Foreign Application Priority Data
Mar. 29, 2004 (EP) 04007587

(51) Int. Cl. A61C 5/08

(52) U.S. Cl. 433/218

(57) ABSTRACT

A method for producing a blank for a permanent dental crown starts with a blank that includes a tooth module and a support. A preparation is formed on the underside and serves for connection to an anchoring element such as a screw element or tooth stump. The tooth module and the support are produced from the same material in a first process that permits a high surface quality. In a second process, the tooth module and support are connected to one another and can then be further processed. This method leads to a high dimensional stability of the resulting crown and permits the use of inexpensive plastic material for a high-quality permanent dental prosthesis.

### REFERENCE TO RELATED APPLICATIONS

This application is a national stage application under 35 USC 371 of International Application No. PCT/EP2005/003251, filed Mar. 29, 2005, which claims the priority of European Application No. 04 007 587.1, filed Mar. 29, 2004, the contents of both of which prior applications are incorporated herein by reference.

### FIELD OF THE INVENTION

The invention relates to a method for producing a precise connection between a crown, including one in several interconnected parts acting as a temporary or permanent crown, and a machine gate, the invention comprising a tooth module, a connection module and any desired machine gate allowing precise machine-controlled working of the tooth module.

### BACKGROUND OF THE INVENTION

Methods for producing dental crowns are known from the published prior art. Regarding the installation time of the tooth replacement, a distinction is made between two indications. One indication is the production of a temporary tooth replacement which is fitted only for a limited period of a few days to weeks. The other indication concerns dental crowns which serve as definitive tooth replacements and often remain in the patient's mouth for years or decades. For the last-mentioned indication of dental crowns, it is also particularly important, in addition to the bite function, to ensure an attractive appearance of the tooth and of its surface. Ceramic has been used mainly as a suitable material for crowns intended as permanent crowns. It has good properties in respect of both functions. However, ceramic is an expensive material to machine.

To reduce costs, it is known to use plastic material instead of ceramic. Although plastic material has the advantage of being much less expensive, a dental crown cannot be produced directly from it by milling in the same way as when using ceramic material. The surface quality that can be achieved by milling of plastic material is not high enough to meet the demands placed on a dental crown serving as a permanent crown. It has therefore been proposed to use, as a starting point, modified artificial teeth, of the kind used for a denture, and to provide them with a suitable support. Difficulties arise here in producing a dimensionally accurate connection between tooth and support.

It is also known to form a tooth replacement from plastic material directly on the patient using a disposable mold (U.S. Pat. No. 4,129,946). A support fitted on the mold is used for handling, while the dental implant itself has no support. The method is aimed at single items and is not suitable for expensive production, in particular serial production.

### SUMMARY OF THE INVENTION

The object of the invention is to improve a method of the type mentioned at the outset so as to permit dimensionally accurate production at less cost.

The solution according to the invention lies in the features of the invention as disclosed broadly herein. Advantageous developments are the subject matter of the specific embodiments disclosed below.

In a method for producing a permanent dental crown, where the crown comprises a tooth module and a support, involving the tooth module being produced in a first process with a high surface quality and a preparation being formed on an underside of the tooth module, the invention provides that the support is produced from the same material as the tooth module and, in a second process, the tooth module and the support are connected to form one unit, the preparation being provided on the underside of the support.

Some of the terms used will first be explained:

A tooth module is understood as that part of a crown, serving as tooth replacement, that forms the tooth body, the greater part of which protrudes visibly from the gum, and whose top face is designed with a biting surface (top face is here to be understood functionally and, in the case of the lower jaw, coincides with the actual spatial relations after fitting, while in the case of the upper jaw it is exactly the reverse). The tooth module does not serve for anchoring in the jaw. A separate anchoring means is provided for this purpose.

The latter can be an artificial anchor (implant), which is screwed into the jaw bone for example, or a tooth stump which is anchored in the jaw via the natural root.

A preparation is understood as a recess which is arranged on the underside (i.e. on the side remote from the biting surface) and which serves to secure the crown for retention on an implant or stump in the jaw.

The connection of the support in the tooth module is expediently formed on its underside. It is thus located on the side directed toward the jaw after fitting and is thus concealed from the observer's view. In this way, any residual traces of machining do not spoil the esthetic appearance. The connection between tooth module and support is advantageously over the whole surface. In this way the entire underside is available for transmission of forces, so that the specific load drops and peak loads are avoided. However, the connection of the support to the tooth module does not necessarily have to be made on the underside; it can also be done on a side surface. This affords the advantage of the tooth module being secured centrally. The machining forces that arise during the subsequent machining then act with a lower lever arm on the connection to the support. The connection is thus subjected to less loading.

The connection between the support and the tooth module is preferably produced without adhesive. It has proven expedient to produce the connection by direct connection.

This is made possible because the tooth module and the support are produced from the same material. The support is preferably designed such that it comprises a tooth module connection part and a securing part designed as extension arm. The provision of an extension arm on the support permits a more favorable securing of the tooth module closer to the center of gravity. It is particularly expedient for the extension arm to be designed as a lateral extension arm. This makes it possible to receive the tooth module at the height of the center of gravity on a machining device. This also results in a very short lever arm between the tooth module and the receiver on the machining device. The deflections of the tooth module, which are unavoidable because of the elasticity of the material used, are minimized in this way. To this end, the securing part is preferably designed such that it withstands at least the machining forces that occur.

In a proven embodiment, a wedge-shaped foot is formed on the securing part. The wedge shape combines the preference for a large securing surface with the advantage of the best possible accessibility of the tooth module. It also provides a secure hold, because the material strength is increased in zones of increasing load. This manner of attachment therefore, one the one hand, is very secure against loading and, on the other hand, permits good access.

The tooth module is preferably a module for front teeth and side teeth. Front teeth differ from side teeth in two respects. On the one hand, they have a different function, namely that of cutting food instead of grinding it, and, on the other hand, they are the most visible teeth. Their esthetic impression is therefore of extraordinary importance. To give them the most natural appearance possible, they need to have a high surface quality. In contrast to customary milling techniques, the production method according to the invention also makes it possible to achieve a high surface quality in a front tooth module produced from plastic material. The desired esthetic impression can be achieved by this means. Thus, the invention allows less expensive plastic material to be used for producing crowns both for the area of the front teeth and also the area of the side teeth.

The support is expediently designed for connection to a machine adapter. This makes it possible to fit the dental implant according to the invention into a machining device. By virtue of the dimensionally accurate connection between the tooth module on the one hand and the support on the other, high-precision machining of the implant can take place.

It has proven expedient to provide, in the machine adapter, at least one channel for delivering molding material and/or adhesive for the implant. By delivery of molding material or adhesive, the implant with the support can be safely secured to the machine adapter.

It is also possible to delivery differently colored material, so as to produce a visibly perceptible difference between different areas of the implant. This need not be limited to the visible separation between tooth module and support, and instead it is possible, where necessary, to use different colors for the tooth module. This can be used advantageously to permit natural coloring, or also for achieving special visual effects. It is also possible to provide a plurality of channels in the machine adapter. The arrangement can be centric or eccentric.

### BRIEF DESCRIPTION OF THE DRAWINGS

The invention is explained below in more detail, and by way of example, with reference to the drawing which depicts an advantageous embodiment, and in which:

FIG. 1 shows a tooth module designed as a front tooth;

FIG. 2 shows a support according to a first illustrative embodiment, provided for connection to the tooth module;

FIG. 3 shows tooth module and support in the connected state;

FIG. 4 shows a machine adapter to be received in the support;

FIG. 5 shows a perspective view of the tooth module according to FIG. 3, with the machine adapter attached; and

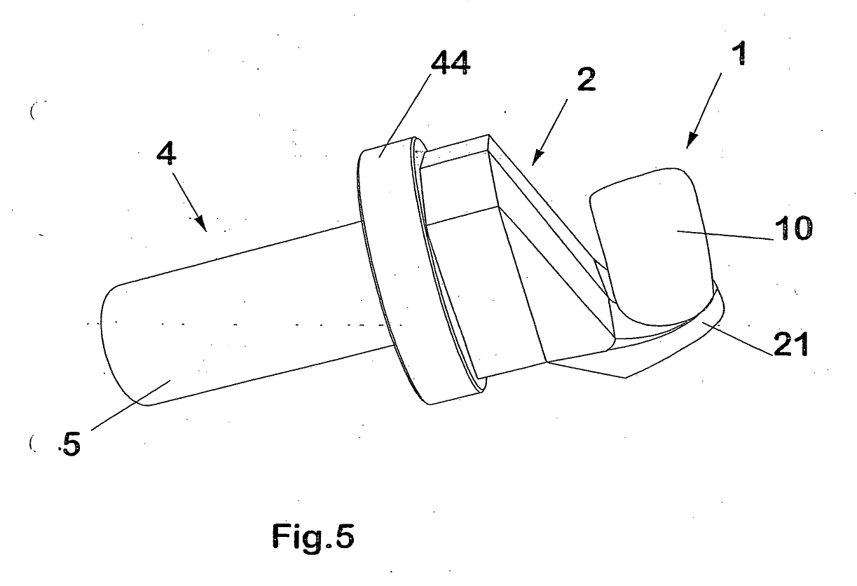

FIG. 6 shows a support according to a second illustrative embodiment of the invention, in the state when connected to the tooth module; and

FIG. 7 shows a perspective view of the implant according to FIG. 6, with the machine adapter attached.

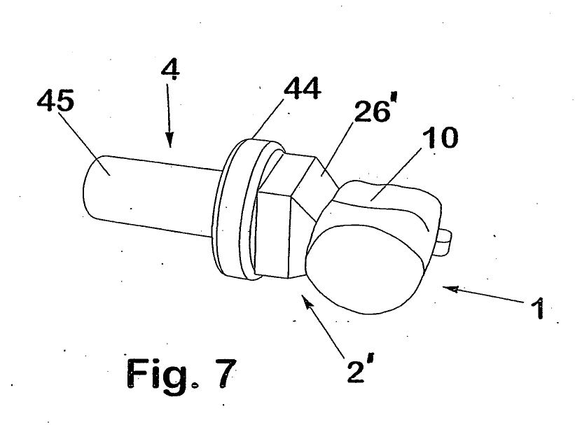

### DETAILED DESCRIPTION OF THE INVENTION

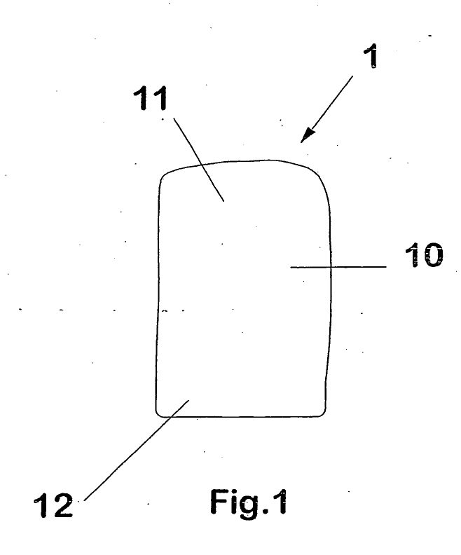

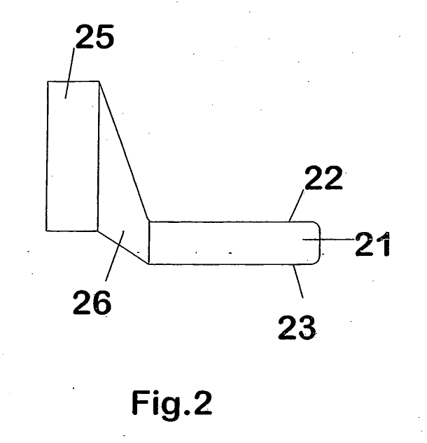

The modules for the production method according to the invention are shown in FIGS. 1 and 2. A front tooth module 1 is shown in FIG. 1. It comprises a tooth body 10 with a biting or cutting surface 11 (lying at the top in the drawing). At the opposite end (the bottom end in the drawing), a connection surface designated as the underside is provided. The tooth is made of a plastic, for example PMMA (polymethylmethacrylate). However, it is not just plastic materials that can be considered for the molding material for the dental implant, but also other materials that are capable of being processed in the stated manner. In particular, the material can also be ceramic, or plastic material filled with glass ceramic. Suitable plastic materials are in particular those based on free-radically polymerizable monomers, which preferably also contain an inorganic filler. Suitable inorganic fillers are in particular SiO2, glasses, ceramic or glass ceramic, and apatite constituents. Other possible materials are ones in which the inorganic constituent or constituents predominate and plasticizing agents are added for processing in paste form.

The tooth involved here can in particular be an artificial tooth produced in a known manner, of the type used for dental prostheses. The underside 12 is preferably flat. These are used to at least partially veneer the transition to the adjacent module. The tooth body 10 can comprise a layered structure, with shading layers being incorporated in order to obtain an impression that is as natural as possible. This applies especially to the area of the biting surface 11 designed as incising edge.

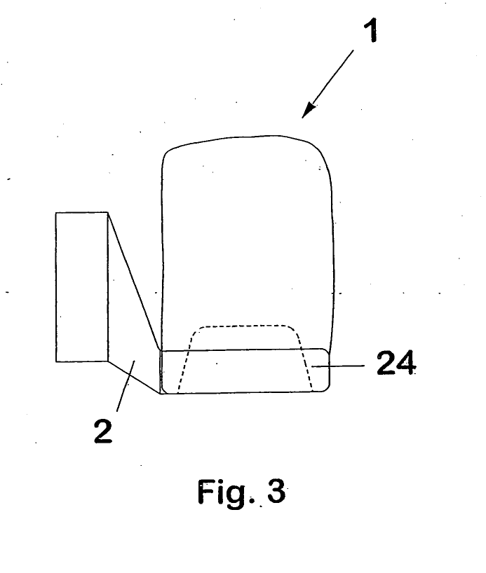

FIG. 2 shows the support, which is designated in its entirety by reference number 2. It comprises a connection part 21 with a top face 22 provided for connection to the front tooth module 1, with a foot 26 and a flange 25. The foot 26 extends obliquely upward from the plate-shaped connection part 21 into an area above the top face 22, and the space immediately above the top face 22 remains free for receiving the front tooth module 1. The foot 26 is wedge-shaped, with a narrow first cross section in the area of transition to the connection part 21, and, in the illustrative embodiment shown, with a substantially wider cross section, about four times as great, in the area of transition to the securing flange 25. This wedge-shaped configuration has the effect that a gap widening upwardly from the top face 22 is formed between the foot 26 and the front tooth module 1 in the applied state (see FIG. 3). This gap permits good accessibility of the front tooth module for subsequent machining steps.

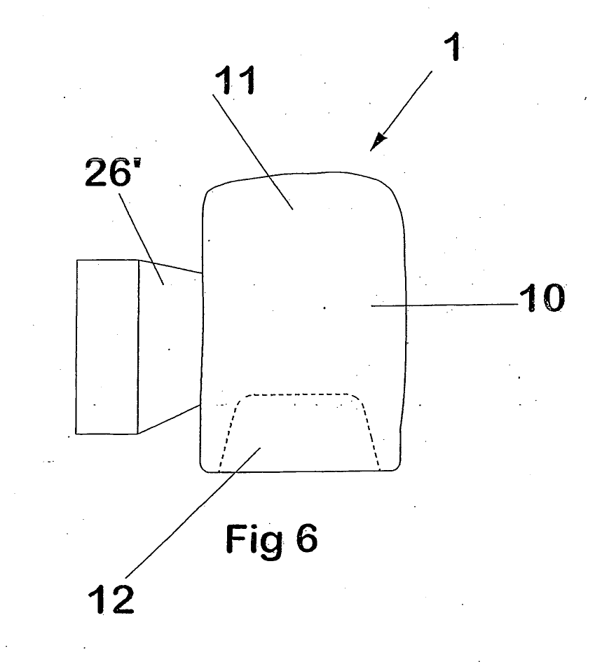

An alternative embodiment of the support is shown in FIG. 6 and designated in its entirety by reference number 2′. Its structure is essentially similar to the support 2 according to the first illustrative embodiment. Only the differences are set out briefly below.

The support 2′ has a foot 26′ of a different design. It is configured such that it touches the distal side of the front tooth module 1 in the applied state. The front tooth module 1 is thus held in a central area, so that only low torques can develop during machining on account of short lever arms. This counters the danger of the connection between the front tooth module 1 and the support 2′ coming loose or even being lost. Moreover, this illustrative embodiment has the advantage that particularly good accessibility of the underside 12 is achieved. This makes subsequent machining simpler.

The explanations given below are for the first illustrative embodiment. They apply by analogy to the second illustrative embodiment. On that side of the securing flange 25 remote from the foot 26, a receiving face for a machine adapter 4 is provided. This receiving face is substantially flat. The flat receiving face serves for mounting the support 2 at the correct angle on the machine adapter 4.

In any desired machine gate 45, a corresponding bearing face 43 and a securing pin 41 with grooves 42 have to be fitted in the opposite part.

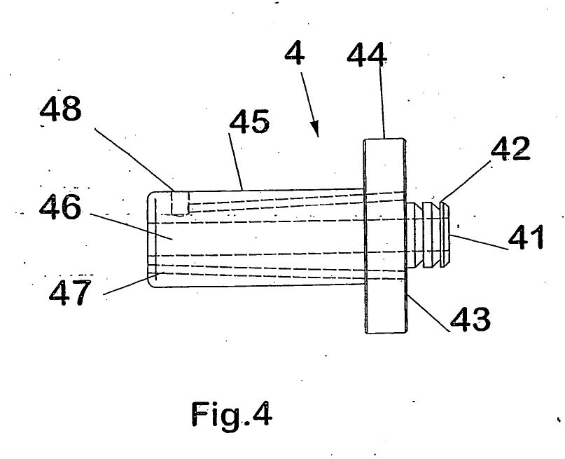

The machine adapter 4 shown in FIG. 4 has optional channels 46, 47, 48 indicated by broken lines. The channel 46 runs through the main body of the machine gate 45 to the opposite end and opens out at the outer end of the securing pin 41. This channel 46 has a relatively large cross section. It is preferably used for guiding molding material, i.e. the material from which the tooth module 1 and the support 2 are made, through the machine adapter 4. The channel 47 extends similarly to the channel 46, but is of smaller cross section and does not open out at the far end of the securing pin 41, but in the bearing face 43. Molding material, in particular for forming the support 2, can be delivered through this channel 47. The channel 47 can in particular also be used to deliver the molding material in another color, in order to achieve the visible separation between tooth module 1 and support 2. Finally, there is also a third channel 48, which runs in a similar way to the channel 47 but has its origin in the jacket surface of the main body of the machine gate 45. This channel 48 can be used in particular to deliver adhesive to the bearing face 43. It will be appreciated that the channels do not necessarily have to be used exclusively for delivering molding material on the one hand or adhesive on the other, but can also alternate between delivering molding material and adhesive.

The production takes place as follows. First, the front tooth module 1 is produced in a first process. In this process, which is known from the production of artificial teeth for dental prostheses and therefore does not have to be described in detail here, the tooth module 1 is produced from plastic material. This process permits the creation of a particularly high surface quality, which gives the tooth module 1 a natural appearance.

This tooth module 1 cannot be used directly as a crown, and instead it still has to be provided with a support which receives a preparation for accommodating an anchoring element for securing the tooth module in the jaw. So as not to impair the natural-looking surface of the tooth module 1, the preparation cannot be formed directly on the tooth module 1, and instead the tooth module 1 has to be arranged on the machining device by way of a support 2. To do so according to the invention, the support 2 preferably made from the same plastic material as the tooth module 1 is connected to the tooth module 1.

In principle, it would be possible for the tooth module 1 and the support 2 to be produced en bloc from the same material in one processing step. However, the disadvantage of this is that, because of unavoidable shrinkage of the plastic material, only a low level of dimensional stability could be achieved. Therefore, the invention provides that the tooth module 1 and the support 2 are produced separately from the same material and that these two modules are connected thereafter.

The tooth module 1 is connected to the support 2 using an adhesive-free connection technique. This can be done in particular by a connection in which the connecting faces to be joined to one another, namely the underside 11 of the tooth module 1 and the top face 22 of the support 2, are connected with the same material by a chemical thermoplastic process. This results in an intimate connection which, in appearance, looks like a seamless connection. With this connection performed in a second production step, the production of the blank for the crown is completed. This can be done in series, and the blanks can be kept in stock.

To prepare for its use, the blank still has to be adapted and for this purpose has to be provided on the underside with the preparation (receiving part for the anchoring element secured in the jaw=implant or tooth stump). This is preferably done by machining. After insertion in the machining device, in particular a computer-controlled milling device, the operations required for the fitting can be performed. The preparation (see broken line 24 in FIG. 3) is formed on the underside 23 of the support 2. By virtue of the support 2, 2′ that is intimately connected to the tooth module 1 and sits securely on the machine adapter 4, a high degree of positioning accuracy and good dimensional stability is guaranteed. When this has been completed, all that need be done is for the foot 26, 26′ to be detached at its transition to the support plate 21. So that this can be done easily, the transition has as small a cross section as possible. It must, however, be configured such that it withstands the machining forces that arise. After separation in this area, the tooth replacement thus created is ready to be fitted. Manual reworking is no longer required, or is required only to a minimal extent.

1. (canceled)

2. The method as claimed in claim 12, further comprising connecting the support to the underside of the tooth module.

3. The method as claimed in claim 2, wherein the support and the tooth module are connected over their full surface.

4. The method as claimed in claim 3, further comprising designing the support with a tooth module connection part and a securing part designed as an extension arm.

5. The method as claimed in claim 4, wherein the securing part for taking up the forces that occur during machining is designed such that it extends at least along the height of the tooth module.

6. The method as claimed in one of claims 3 through 5, further comprising forming the securing part.

7. The method as claimed in one of claims 12 and 2 through 5, wherein the dental crown comprises interconnected parts.

8. The method as claimed in one of claims 12 and 2 through 5, wherein the tooth module is a front tooth module.

9. (canceled)

10. The method as claimed in one of claims 2 through 5 and 12, further comprising providing a machine adapter with at least one channel for delivering molding material or adhesive for the implant.

11. The method as claimed in one of claims 12 and 2 through 5, wherein the material used is plastic, ceramic, or plastic material filled with glass ceramic.

12. A method for producing a blank for a permanent dental crown comprising a tooth module and a support, the method comprising:
forming the tooth module and the support from a same material in a first process to impart a high surface quality,
forming a preparation on an underside of the tooth module configured to serve as a connection to an anchor arranged in a jaw of a subject, and
joining the tooth module and the support together to form the blank as one unit in a second process.

13. The method as claimed in claim 3, wherein the extension arm is a lateral extension arm.

14. The method as claimed in claim 10, comprising designing the support to be configured for connection to the machine adapter.
